(19) United States
(12) Patent Application Publication
(10) Pub. No.: US 2014/0219090 A1
(43) Pub. Date: Aug. 7, 2014

(54) NETWORK CONGESTION REMEDIATION UTILIZING LOOP FREE ALTERNATE LOAD SHARING

(71) Applicant: TELEFONAKTIEBOLAGET L M ERICSSON (PUBL), Stockholm (SE)

(72) Inventors: Selvam Ramanathan, Sunnyvale, CA (US); Alok Gulati, San Jose, CA (US)

(73) Assignee: TELEFONAKTIEBOLAGET L M ERICSSON (PUBL), Stockholm (SE)

(21) Appl. No.: 13/758,642

(22) Filed: Feb. 4, 2013

(51) Int. Cl. H04L 12/56

(52) U.S. Cl. CPC H04L 47/621
USPC 370/235

(57) ABSTRACT

Methods and apparatus for network congestion remediation utilizing loop free alternate load sharing within a network device are described. The network device monitors a plurality of egress output queues. Upon detecting congestion at one of the output queues that is a primary next hop for traffic matching an entry of a forwarding table, the network device causes some of the affected traffic to continue to utilize the congested output queue and some of the affected traffic to utilize a loop free alternate next hop via a different output queue at a different port. Upon detecting an end to the congestion, the network device sends all of the affected traffic using the primary next hop.

### FIELD

Embodiments of the invention relate to the field of computer networking; and more specifically, to reducing congestion within a communications network using loop free alternate load sharing.

### BACKGROUND

Network congestion occurs when a link or node is carrying so much data that its quality of service (QoS) deteriorates. Typical network congestion effects include increases in queuing delay (an average time that packets wait in a queue before being processed and forwarded), packet loss due to full packet queues or the use of active queue management by a forwarding node, and/or the blocking of new connections. A consequence of these latter two network congestion effects (packet loss, connection blocking) is that incremental increases in offered load lead either only to small increases in network throughput, or to an actual reduction in network throughput.

One method for handling network congestion is the use of Explicit Congestion Notification (ECN), which is an extension to the Internet Protocol (IP) and to the Transmission Control Protocol (TCP) and is defined in Institute of Electrical and Electronics Engineers (IEEE) Request for Comments (RFC) 3168, titled “The Addition of Explicit Congestion Notification (ECN) to IP.”

In scenarios when ECN is successfully negotiated, an ECN-aware router may set an indication (i.e., two bits) in the IP header of a packet instead of dropping that packet in order to signal impending congestion. The recipient of the packet echoes this congestion indication to the sender, which reduces its transmission rate as though it detected a dropped packet. While ECN can reduce network congestion, ECN suffers from several flaws. First, ECN is an optional feature that is only used when both endpoints support it and are willing to use it, which is not always the case. Second, ECN is only effective when it is supported by the underlying network. Third, TCP/IP networks conventionally signal congestion by dropping packets. Finally, if a network is congested, the receiver of the packet may not receive a packet including the ECN indication or may only receive such a packet after a long amount of time, perhaps when the network has already recovered from the congestion. Accordingly, it would be desirable to have other methods to identify, reduce, and prevent network congestion that do not suffer from these deficiencies.

### SUMMARY

Systems, methods, and apparatus for network congestion remediation utilizing loop free alternate load sharing are described. According to an embodiment of the invention, a method in a network device in a communications network reduces congestion within the communications network by monitoring a congestion level of a plurality of output queues for a plurality of ports of the network device. The network device includes a forwarding table, which includes a first entry that identifies a first port of the plurality of ports as a primary next hop. The method further includes detecting, based upon said monitoring, that a first output queue of the plurality of output queues is congested. The first output queue is for the first port. The method also includes receiving a plurality of packets from a set of one or more network devices in the communications network. Each of the plurality of packets matches the first entry in the forwarding table. The method also includes, responsive to the first port being congested, transmitting a first set of one or more packets of the plurality of packets using the first port and transmitting a second set of one or more packets of the plurality of packets using a second port of the network device.

According to another embodiment of the invention, a method in an ingress packet forwarding engine (PFE) of a network device can reduce congestion within a communications network by receiving, from an egress PFE of the network device, a queue congestion message indicating that a first output queue for a first port is congested. The first port is identified by a first entry of a forwarding table as a primary next hop. The method also includes receiving a plurality of packets transmitted by a set of one or more network devices of the communications network. A portion of each of the plurality of packets matches the first entry in the forwarding table. In response to receiving the queue congestion message, the ingress PFE causes the egress PFE to transmit a first set of one or more of the plurality of packets using the first port and a second set of one or more of the plurality of packets using a second port of the network device.

In another embodiment, an ingress packet forwarding engine (PFE) can to be utilized within a network device to reduce congestion in a communications network. The ingress PFE includes an ingress forwarding module and an adjacency selection module. The ingress forwarding module is configured to receive, from an egress PFE of the network device, a queue congestion message. The queue congestion message indicates that a first output queue for a first port of the network device is congested. The first port is identified by a first entry of a forwarding table as a primary next hop. The ingress forwarding module is also configured to receive, from a set of one or more network devices, a plurality of packets to be forwarded by the network device. A portion of each packet of the plurality of packets matches the first entry of the forwarding table. The adjacency selection module is coupled to the ingress forwarding module and is configured to cause, responsive to the ingress forwarding module receiving the queue congestion message, the egress PFE to transmit a first set of one or more of the plurality of packets using the first port and transmit a second set of one or more of the plurality of packets using a second port of the network device.

In an embodiment of the invention, a router performs a method to reduce congestion in a communications network. The method includes detecting, by an egress packet forwarding engine (PFE) of the router, that an output queue for a first port of the router is congested. The method also includes sending, from the egress PFE to a set of one or more ingress PFEs of the router, a queue congestion message that indicates that the output queue for the first port is congested. The method further includes receiving a plurality of packets to be forwarded. A portion of each of the plurality of packets matches a first entry of a forwarding table. The first entry identifies the first port as a primary next hop and a second port of the router as a loop-free alternate (LFA) next hop. The router selects, for a first set of one or more packets of the plurality of packets, the primary next hop to be used to transmit the first set of packets, and also selects for a second set of one or more packets of the plurality of packets the LFA next hop to be used to transmit the second set of packets. The router transmits the first set of packets using the first port and the second set of packets using the second port.

Embodiments of the invention allow a network device to unilaterally detect network congestion and quickly act to remediate the congestion without relying upon any other actor in the network. Further, in computer networks where multiple network devices are so configured, congestion throughout the network is able to be reduced and traffic will “naturally” be diffused throughout the network without any coordination required between the multiple network devices.

### BRIEF DESCRIPTION OF THE DRAWINGS

The invention may best be understood by referring to the following description and accompanying drawings that are used to illustrate embodiments of the invention. In the drawings:

FIG. 1 illustrates a block diagram of a network device utilizing network congestion remediation through loop free alternate (LFA) load sharing according to one embodiment of the invention;

FIG. 2 illustrates a sequence diagram for non-congestion forwarding according to one embodiment of the invention;

FIG. 3 illustrates a sequence diagram for congestion remediation LFA forwarding according to one embodiment of the invention;

FIG. 4 illustrates a sequence diagram for ending congestion remediation LFA forwarding according to the embodiment of the invention depicted in FIG. 3;

FIG. 5 illustrates a flow in a network device for network congestion remediation utilizing loop free alternate load sharing according to one embodiment of the invention; and

FIG. 6 illustrates a flow in an ingress packet forwarding engine (PFE) for network congestion remediation utilizing loop free alternate load sharing according to one embodiment of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Within the figures, bracketed text and blocks with dashed borders (e.g., large dashes, small dashes, dot-dash, dots) are used herein to illustrate optional operations that add additional features to embodiments of the invention. However, such notation should not be taken to mean that these are the only options or optional operations, and/or that blocks with solid borders are not optional in certain embodiments of the invention.

An electronic device (e.g., an end station, a network device) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals—such as carrier waves, infrared signals). In addition, such electronic devices includes hardware such as a set of one or more processors coupled to one or more other components, such as one or more non-transitory machine-readable media (to store code and/or data), user input/output devices (e.g., a keyboard, a touchscreen, and/or a display), and network connections (to transmit code and/or data using propagating signals). The coupling of the set of processors and other components is typically through one or more busses and bridges (also termed as bus controllers). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device (e.g., a router, switch, bridge) is a piece of networking equipment, including hardware and software, which communicatively interconnects other equipment on the network (e.g., other network devices, end stations). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Subscriber end stations (e.g., servers, workstations, laptops, netbooks, palm tops, mobile phones, smartphones, multimedia phones, Voice Over Internet Protocol (VOIP) phones, user equipment, terminals, portable media players, GPS units, gaming systems, set-top boxes) access content/services provided over the Internet and/or content/services provided on virtual private networks (VPNs) overlaid on (e.g., tunneled through) the Internet. The content and/or services are typically provided by one or more end stations (e.g., server end stations) belonging to a service or content provider or end stations participating in a peer to peer service, and may include, for example, public webpages (e.g., free content, store fronts, search services), private webpages (e.g., username/password accessed webpages providing email services), and/or corporate networks over VPNs. Typically, subscriber end stations are coupled (e.g., through customer premise equipment coupled to an access network (wired or wirelessly)) to edge network devices, which are coupled (e.g., through one or more core network devices) to other edge network devices, which are coupled to other end stations (e.g., server end stations).

Network devices are commonly separated into a control plane and a data plane (sometimes referred to as a forwarding plane or a media plane). In the case that the network device is a router (or is implementing routing functionality), the control plane typically determines how data (e.g., packets) is to be routed (e.g., the next hop for the data and the outgoing port for that data), and the data plane is in charge of forwarding that data. For example, the control plane typically includes one or more routing protocols (e.g., Border Gateway Protocol (BGP), Interior Gateway Protocol(s) (IGP) (e.g., Open Shortest Path First (OSPF), Routing Information Protocol (RIP), Intermediate System to Intermediate System (IS-IS)), Label Distribution Protocol (LDP), Resource Reservation Protocol (RSVP)) that communicate with other network devices to exchange routes and select those routes based on one or more routing metrics.

Routes and adjacencies are stored in one or more routing structures (e.g., Routing Information Base (RIB), Label Information Base (LIB), one or more adjacency structures) on the control plane. The control plane programs the data plane with information (e.g., adjacency and route information) based on the routing structure(s). For example, the control plane programs the adjacency and route information into one or more forwarding structures (e.g., Forwarding Information Base (FIB), Label Forwarding Information Base (LFIB), and one or more adjacency structures) on the data plane. The data plane uses these forwarding and adjacency structures when forwarding traffic.

Each of the routing protocols downloads route entries to a main RIB based on certain route metrics (the metrics can be different for different routing protocols). Each of the routing protocols can store the route entries, including the route entries which are not downloaded to the main RIB, in a local RIB (e.g., an OSPF local RIB). A RIB module that manages the main RIB selects routes from the routes downloaded by the routing protocols (based on a set of metrics) and downloads those selected routes (sometimes referred to as active route entries) to the data plane. The RIB module can also cause routes to be redistributed between routing protocols.

For layer 2 forwarding, the network device can store one or more bridging tables that are used to forward data based on the layer 2 information in that data.

Typically, a network device includes a set of one or more line cards, a set of one or more control cards, and optionally a set of one or more service cards (sometimes referred to as resource cards). These cards are coupled together through one or more mechanisms (e.g., a first full mesh coupling the line cards and a second full mesh coupling all of the cards). The set of line cards make up the data plane, while the set of control cards provide the control plane and exchange packets with external network devices through the line cards. The set of service cards can provide specialized processing (e.g., Layer 4 to Layer 7 services (e.g., firewall, Internet Protocol security (IPsec), Intrusion Detection System (IDS)), Voice over Internet Protocol (VoIP) Session Border Controller, Mobile Wireless Gateways (Gateway General Packet Radio Service (GRPS) Support Node (GGSN), Evolved Packet System (EPS) Gateway)). By way of example, a service card may be used to terminate IPsec tunnels and execute the attendant authentication and encryption algorithms.

IEEE RFC 5286 provides a specification for IP Fast Reroute: Loop-Free Alternates. RFC 5286 describes the use of loop-free alternates (LFAs) to provide local protection for unicast traffic in pure IP and Multiprotocol Label Switching (MPLS)/Label Distribution Protocol (LDP) networks in the event of a single failure in the network. This technology aims to reduce the packet loss that happens while routers converge after a topology change due to a failure. Rapid failure repair is achieved through use of pre-calculated backup next-hops that are loop-free and safe to use until the distributed network convergence process completes, and the process does not require any support from other routers. The alternate next-hop can protect against a single link failure, a single node failure, failure of one or more links within a shared risk link group (SRLG), or a combination of these.

Methods, apparatuses, and systems for network congestion remediation through loop free alternate load sharing are described. In one embodiment of the invention, a set of output queues of a network device are monitored. Upon detection of congestion at a port, the network device updates, for that affected traffic to be transmitted over the congested port, its forwarding logic to forward some of that affected traffic over the congested port and some of that affected traffic over an alternate port. In an embodiment of the invention, the alternate port is a Loop Free Alternate (LFA) next hop. Upon detection of an end to the congestion at the port, the network device is configured to update its forwarding logic to again transmit the affected traffic over the original, previously-congested port. Accordingly, by utilizing pre-calculated LFA next hops for purposes outside of their originally intended use (e.g., for congestion handling, as opposed to outright failure handling), embodiments of the invention allow the network device to unilaterally detect congestion and quickly act to remediate the congestion (i.e., self-heal) without reliance upon other actors in a network. Further, in computer networks where multiple network devices are so configured, congestion throughout the network is able to be reduced and traffic will “naturally” be diffused.

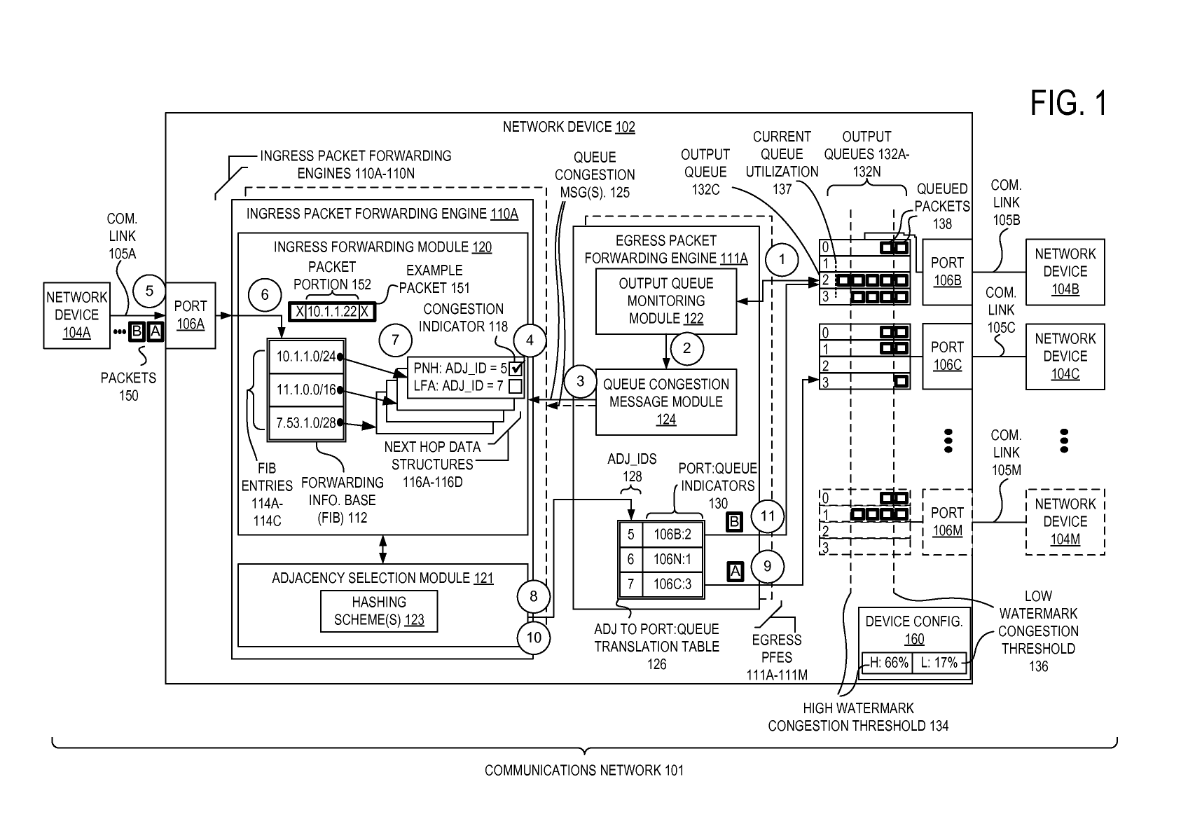

FIG. 1 illustrates a block diagram of a network device 102 utilizing network congestion remediation through loop free alternate load sharing according to one embodiment of the invention. In this depicted embodiment, the network device 102 is coupled to a plurality of other network devices 104A-104M over communication links 105A-105M (e.g. optical cable, Ethernet cable, etc.) within a communications network 101, but in other embodiments there may be more or fewer such network devices in the communications network 101. The reference number portion “M” of network device 104M here represents some integer number larger than three (as network devices 104A, 104B, and 104C are depicted) and is not specifically intended to represent any particular number (though, again, in certain embodiments there are fewer than three network devices in the communications network 101). Similarly, unless otherwise indicated, any use herein of a reference numeral ending in “N” or “M” is to be treated as a placeholder for any particular integer value, subject to the context of its use.

The network device 102 illustrated in FIG. 1 includes one or more ingress packet forwarding engines (PFEs) 110A-110N, one or more egress PFEs 111A-111M, and a plurality of ports 106A-106M. In an embodiment, each of the plurality of ports 106A-106M is a physical network interface port. In an embodiment, all or some of the ingress PFEs 110A-110N and/or all or some of the egress PFEs are each provided by a different line card. However, in some embodiments, more than one ingress PFE 110A-110N and/or egress PFE 111A-111M are provided by a line card and in other embodiments some or all of the ingress PFEs 110A-110N and/or some or all of the egress PFEs 111A-111M are not provided by a line card.

The ingress PFEs 110A-110N are utilized by the network device 102 to receive packets (e.g., packets 150) transmitted by network devices 104A-104M that are to be forwarded by the network device 102 to one or more other of the network devices 104A-104M. With these received packets 150, the ingress PFE (e.g., 110A) utilizes forwarding logic to determine which port of the plurality of ports 106A-106M each packet should be forwarded on. In an embodiment, the forwarding logic of an ingress PFE includes a Forwarding Information Base (FIB) 112 that includes one or more FIB entries 114A-114C including an address prefix. Upon receipt of a packet (e.g., 151), a portion 152 of the packet 151 is compared to the prefixes within the FIB entries to find a matching FIB entry. In an embodiment, a FIB entry identifies (or points to) a next hop data structure (e.g., 116A). While the next hop data structures 116A-116D are illustrated in FIG. 1 as being external to the FIB 112, in other embodiments they may be a part of the FIB. In this depicted embodiment, each next hop data structure (e.g., 116A) identifies a primary next hop (“PNH”) and a loop-free alternate next hop (“LFA”). In the depicted embodiment, the next hop data structure 116A PNH and LFA identify an adjacency identifier, which is a value that maps to a port identifier (see, e.g., the adjacency to port and queue translation table 126, which maps adjacency identifiers (IDs) 128 to port and queue indicators 130). In various embodiments of the invention, the PNH and LFA may directly or indirectly identify a port identifier.

The ingress PFEs 110A-110N also include, in the depicted embodiment of FIG. 1, an adjacency selection module 121 that is coupled to the ingress forwarding module 120 and is configured to cause the egress PFE to transmit a received packet using a particular queue (e.g. 132C) and/or port (e.g. 106B) by determining which next hop (i.e., the PNH or the LFA) in an next hop data structure (e.g., 116A) is to be utilized. In embodiments of the invention, the adjacency selection module 121 makes this determination based upon congestion indicators 118 that indicate which, if any, of the output queues 132A-132N and/or ports 106A-106M and/or adjacencies are currently congested. In the depicted embodiment, if the adjacency identifier of the primary next hop (PNH) of an identified next hop data structure (e.g. 116A) is not determined to be congested based upon an associated congestion indicator 118, then the adjacency selection module 121 selects the PNH adjacency identifier to be used for forwarding. However, if the congestion indicator 118 for the PNH adjacency identifier does indicate that the queue for that adjacency is congested, the adjacency selection module 121 may select either the PNH adjacency ID or the LFA adjacency ID. In an embodiment, the adjacency selection module 121 utilizes one or more hashing schemes 123 to make this selection between the PNH and the LFA adjacency IDs such that some packets matching a particular FIB entry (e.g. 114A) that identifies a particular next hop data structure (e.g. 116A) will be transmitted using the PNH and other packets matching that same particular FIB entry 114A will be transmitted using the LFA. Although various hashing schemes 123 are well known to those in the art, one hashing scheme 123 utilizes a user-configurable policy based upon one or more portions of the matching packet, including but not limited to a source IP address, a destination IP address, Internet socket port numbers (e.g., an incoming port, a destination port), etc. In other embodiments, a hashing scheme 123 utilizes a value generated by the network device 102, such as a portion of or all of a time value generated by a clock module. In some embodiments, the hashing scheme is configured to result in approximately half of all packets being transmitted over the PNH and half over the LFA, but in other embodiments the hashing scheme may result in other load distributions (e.g. 70% vs. 30%, etc.). Additionally, the hashing scheme 123 in some embodiments may be configured to place high priority and/or time sensitive traffic (e.g., streaming video, VoIP traffic) over the PNH and lower priority and/or less time sensitive traffic (e.g., web browsing traffic) over the LFA next hop.

The egress PFEs 111A-111M are utilized by the network device 102 to take the received packets 150 and transmit them using the plurality of ports 106A-106M. In the depicted embodiment, the egress PFE 111A receives an identification 148 of an adjacency identifier that is to be used to forward a particular packet, which is translated using a port using an adjacency to port and queue translation table 126 that includes one or more entries that each include an adjacency identifier 128 and a port and queue identifier 130. In some embodiments where there is only one output queue (e.g. 132A) for a port, the port and queue identifier 130 may not contain a queue identifier because it is implicit. In other embodiments of the invention, the egress PFE 111A receives from an ingress PFE 110A a port identifier and/or a queue identifier, and thus the egress PFE 111A does not need or have an adjacency to port and queue translation table 126. Once the port and queue for a packet is identified, the egress PFE 111A causes the packet to be transmitted by placing the packet into the identified queue of the output queues 132A-132N. As the port (e.g., 106B) transmits the packets (e.g. 138) in its queues (e.g. 132A-132D), each transmitted packet is then removed from its queue.

One or more of the egress PFEs 111A-111M, in the depicted embodiment of FIG. 1, also include an output queue monitoring module 122 coupled to a queue congestion message module 124. The output queue monitoring module 122 is configured to monitor one or more of the output queues 132A-132N to detect when a particular queue (e.g. 132C) is congested. In some embodiments, a queue is deemed congested when a current queue utilization meets or exceeds a high watermark congestion threshold 134, which is a threshold defined by device configuration 160 that indicates when a queue is congested. In some embodiments, the high watermark congestion threshold 134 is a value representing a particular number of packets, and in some embodiments it is a value representing a particular amount of storage space. For example, a queue may be deemed congested when it is storing at least a particular number of packets or when the amount of storage space (e.g., in bits, bytes, kilobytes, megabytes, etc.) occupied by packets it is storing is equal to or greater than a particular percentage of that queue's total amount of storage space.

Some embodiments of the invention utilize just one threshold (i.e., the high watermark congestion threshold 134). In these embodiments, when an addition of one or more packets to a queue (e.g., 138) first causes the high watermark congestion threshold 134 to be met or exceeded, the output queue monitoring module 122 deems the queue congested. Then, upon a point where the removal of one or more packets (due to, for example, the transmission of packets by a port) causes the high watermark congestion threshold 134 to no longer be met or exceeded, the output queue monitoring module 122 will deem the queue not to be congested.

In some embodiments, when the high watermark congestion threshold 134 is met or exceeded, the output queue monitoring module 122 will wait a period of time (e.g., 1 ms, 10 ms, 50 ms, 100 ms, 500 ms, etc.) before determining that the queue is congested. In some of those embodiments, if the utilization of the queue drops beneath the high watermark congestion threshold 134 at any point during the waiting period, the output queue monitoring module 122 will not deem the queue congested. In other of those embodiments, though, the queue utilization must only be above the high watermark congestion threshold 134 at the time the waiting period of time ends; thus, any dips below the high watermark congestion threshold 134 will not prevent the output queue monitoring module 122 from deeming the queue congested.

In some embodiments of the invention, the network device 102 is configured to utilize both a high watermark congestion threshold 134 and a low watermark congestion threshold 136, which prevents a thrashing of rapid determinations of congestion and non-congestion as packets are added and removed. The low watermark congestion threshold 136 is a configurable value to indicate, for example, a number of packets stored or an amount of storage space utilized that will cause the queue to no longer be deemed congested. Thus, when the output queue monitoring module 122 deems a queue congested, the output queue monitoring module 122 will only deem the queue to not be congested when its utilization falls below the low watermark congestion threshold 136. Of course, some embodiments using both a high watermark congestion threshold 134 and a low watermark congestion threshold 136 may also employ the waiting periods described above.

In some embodiments of the invention, the high watermark congestion threshold 134 and/or low watermark congestion threshold 136 are global in that they apply to each output queue 132A-132N in the network device 102, but in other embodiments there are multiple high watermark congestion threshold 134 values and/or low watermark congestion threshold 136 values, allowing different output queues 132A-132N and/or ports 106A-106M to have different definitions of what is or is not congestion.

When the output queue monitoring module 122 switches the congestion status of a queue (from either congested to non-congested, or from non-congested to congested), the output queue monitoring module 122 will cause the queue congestion message module 124 to transmit one or more queue congestion messages 125 to one or more ingress PFEs 110A-110N of the network device 102. These queue congestion messages 125 indicate that a particular queue and/or port is congested or is not congested, depending upon the determination by the output queue monitoring module 122. In some embodiments of the invention, the queue congestion messages 125 are hardware interrupt-driven Fast Failure Notifications (FFNs). Responsive to receipt of a queue congestion message 125, an ingress PFE may update one or more data structures (e.g., change a congestion indicator 118 in one or more next hop data structures 116A-116D) to reflect that the queue and/or port is or is not congested.

One exemplary use case is illustrated through circles ‘1’ to ‘11’ in FIG. 1. At circle ‘1’, an output queue monitoring module 122 of an egress PFE 111A detects that an output queue 132C of a set of one or more output queues (e.g., 132A-132D) for a port 106B is congested. In the depicted embodiment, a packet has just been placed in queue ‘2’ 132C of port 106B (leading to network device 104B over communications link 105B) that caused the utilization of queue ‘2’ to exceed the high watermark congestion threshold 134 (e.g., 66% of the storage capacity of the output queue being utilized) of device configuration 160.

Upon detecting that the high watermark congestion threshold 134 for this output queue 132C has been exceeded, the output queue monitoring module 122, at circle ‘2’, causes the queue congestion message module 124 to transmit a queue congestion message 125 to one or more ingress PFEs 110A-110N indicating the output queue 132C and/or port 106B suffering from congestion and indicating that congestion has begun for this output queue 132C and/or port 106B. In an embodiment, the queue congestion message module 124 transmits a queue congestion message 125 to the ingress PFEs 110A-110N being utilized in the network device 102, and in some embodiments, the queue congestion message 125 is a FFN message. In the depicted embodiment of FIG. 1, the queue congestion message module 124 determines all of the affected adjacency IDs utilizing the congested port and queue using the adjacency to port and queue translation table 126, and then transmits a queue congestion message 125 that includes an indication that congestion has begun for those affected adjacency IDs (in this depicted scenario, only adjacency ID 5).

Upon receipt of the queue congestion message 125 indicating that congestion has begun for a set of one or more adjacency IDs, the ingress forwarding module 120 of the ingress PFE 110A updates, at circle ‘4’, one or more data structures to indicate that the output queue 132C and/or port 106B is congested. In the depicted embodiment, the ingress forwarding module 120 updates a congestion indicator 118 for any PNH or LFA entry in any of the next hop data structures 116A-116D that is configured to utilize adjacency ID ‘5’, which in FIG. 1 includes at least the PNH entry for the next hop data structure 116A pointed to by the first FIB entry 114A.

Next, at circle ‘5’, a plurality of packets 150 (here, two packets 150) are received from one or more network devices (e.g., 104A) at port 106A. At circle ‘6’, the packets are processed by the ingress forwarding module 120 of the ingress PFE 110A. Each of the plurality of packets 150 contains a packet portion 152 that matches a single FIB entry 114A. In the depicted embodiment, the FIB 112 includes destination IP address prefixes; in other embodiments, the FIB 112 may use one or more fields including the same field and/or other fields of a received packet. In the depicted scenario, each of the packets 150 has a destination IP address of ‘10.1.1.22’, which matches the IP address prefix of ‘10.1.1.0/24’ (in Classless Inter-Domain Routing (CIDR) notation) in the first FIB entry 114A. At circle ‘7’, the ingress forwarding module determines that the matched first FIB entry 114A identifies a first next hop data structure 116A.

While in non-congestion scenarios the PNH adjacency ID of the first next hop data structure 116A would be selected as the adjacency ID identifying the next hop, the adjacency selection module 121 will detect that the congestion indicator 118 for the PNH adjacency ID of the first next hop data structure 116A indicates that the output queue 132C utilized by the PNH adjacency ID (e.g., ‘5’) is congested, and will send some traffic over the PNH and some traffic over the LFA next hop. For the first packet ‘A’ of the plurality of packets 150, the adjacency selection module 121 will execute a hashing scheme 123 and determine that this first packet ‘A’ will be forwarded using the LFA next hop, or adjacency ID of ‘7’. Thus, at circle ‘8’, the adjacency selection module 121 causes egress PFE 111A to look up a port and queue using adjacency ID ‘7’ for the first packet ‘A’ in the adjacency to port and queue translation table 126, which results in output queue ‘3’ (e.g. 132H) of port 106C being selected to be used for transmission. Accordingly, at circle ‘9’, the first packet ‘A’ is placed in the output queue 132H for port 106C to be sent to network device 104C. At that point, network device 104C will need to forward the packet toward the original destination identified by the packet portion 152, which is IP address 10.1.1.22.

After processing the first packet ‘A’ of the plurality of received packets 150 matching the first FIB entry 114A, the adjacency selection module 121 will process a second packet ‘B’ and again detect that the congestion indicator is indicating that the PNH is congested. In response, the adjacency selection module 121 will again perform the hashing scheme 123, but will this time determine that the second packet ‘B’ is to be transmitted using the PNH adjacency ID of ‘5’. Accordingly, at circle ‘10’ the adjacency selection module 121 causes egress PFE 111A to look up a port and queue using adjacency ID ‘5’ for the second packet ‘B’ in the adjacency to port and queue translation table 126, which results in output queue ‘2’ (e.g. 132C) of port 106B being selected to be used for transmission. Accordingly, at circle ‘11’, the second packet ‘B’ is placed in the output queue 132C for port 106B to be sent to network device 104B. At that point, network device 104B will need to forward the packet toward the original destination identified by the packet portion 152, which is IP address 10.1.1.22.

In this manner, while an adjacency ID (which identifies an output queue and port) of a PNH is marked as congested, the adjacency selection module 121 is thusly configured to automatically split traffic matching such a FIB entry (e.g., 114A) between two different ports, which will typically allow the congested output queue (e.g., 132C) to recover. However, when the adjacency ID of a PNH is not marked as congested, the adjacency selection module 121 is configured to send all traffic matching that FIB entry 114A on the PNH. Thus, when a number of queued packets 138 or amount of storage space consumed by the queued packets 138 in output queue 132C for port 106B falls beneath the low watermark congestion threshold 136 (e.g., 17% of the storage space being utilized by queued packets), the congestion indicator 118 will be removed for adjacency ID ‘5’ and all traffic matching the first FIB entry 114A will be forwarded using adjacency ID ‘5’ and output queue 132C and port 106B, at least until congestion occurs once again in that output queue.

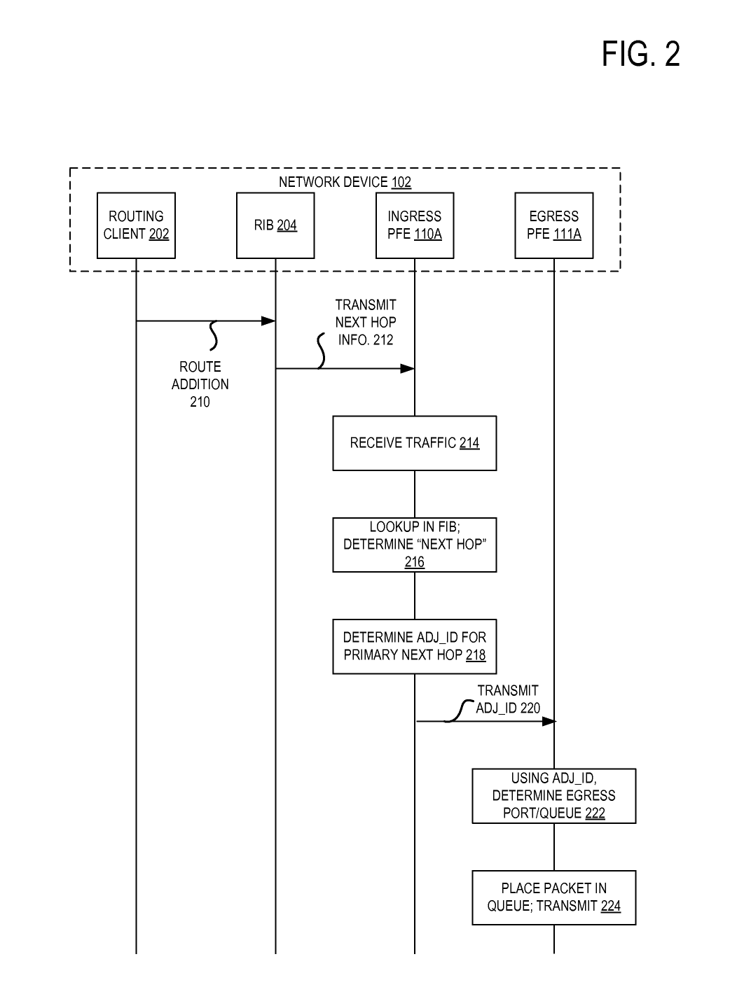

FIG. 2 illustrates a sequence diagram for non-congestion forwarding according to one embodiment of the invention, which includes interactions between a routing client 202, a routing information base (RIB) 204, an ingress PFE 110A, and an egress PFE 111A, which optionally may all exist within one network device 102. When a routing client 202 calculates routes for traffic and performs a route addition 210, in response the RIB 204 creates a next hop data structure including a primary next hop (PNH) identifier and a loop-free alternate (LFA) next hop identifier. This next hop data structure information, along with any new routes or updated routes, is transmitted 212 by the RIB 204 to all ingress PFEs in the network device 102—in this case, to ingress PFE 110A—which stores the next hop data structure and updates its FIB with the new route information. After this point, the ingress PFE 110A receives incoming traffic 214 on a same route. At 216, each packet of this traffic is looked up in the FIB, which all matches a same FIB entry. The result of this lookup 216—or FIB resolution—yields the newly created next hop data structure. At 218, the ingress PFE determines that the PNH is not marked with a positive congestion indicator, so the adjacency ID for the PNH is selected as the adjacency to be used for forwarding the traffic. At 220, the adjacency ID is transmitted to egress PFE 111A, which at 222 uses the adjacency ID to determine which egress port and queue is to be utilized for the traffic. At 224, the egress PFE 111A places the traffic in that queue and after a period of time, the traffic is sent out the egress port and removed from the queue.

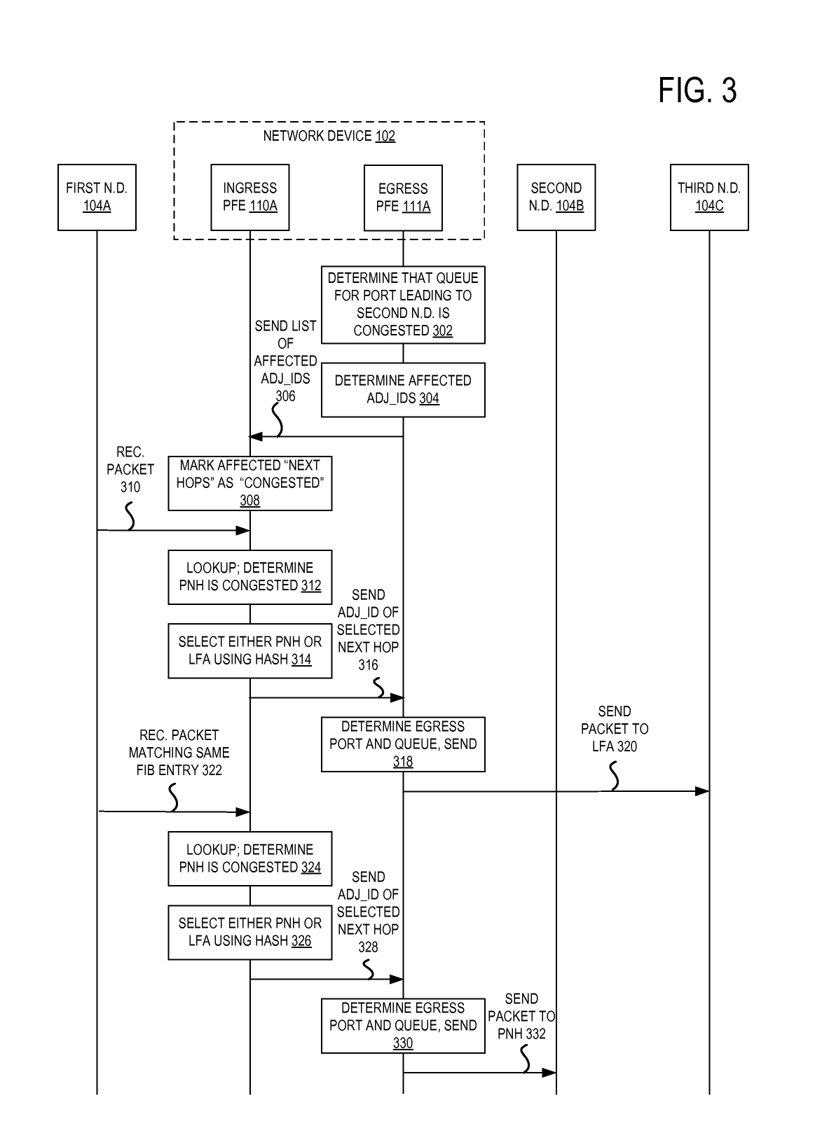

FIG. 3 illustrates a sequence diagram for congestion remediation LFA forwarding according to one embodiment of the invention. FIG. 3 includes a network device 102 employing network congestion remediation utilizing loop free alternate load sharing coupled to a first 104A, second 104B, and third network device 104C.

At 302, the egress PFE 111A, through a monitoring of output queues, determines that an output queue for a port leading through a communications link to a second network device 104B is congested. Responsive to the determination, the egress PFE 111A determines a set of one or more affected adjacency IDs 304 that utilize the congested output queue. The egress PFE then sends 306 a list of the set of affected adjacency IDs to each ingress PFE in the network device 102—here, ingress PFE 110A. The ingress PFE 110A, responsive to receipt of the list of the set of affected adjacency IDs, updates 308 each affected PNH and LFA next hop utilizing an adjacency ID in the set of affected adjacency IDs as congested.

Next, a packet from the first network device 104A is received at 310 by the ingress PFE 110A, and a forwarding lookup 312 results in a first FIB entry being matched that identifies a PNH that is marked as congested. Responsive to this forwarding lookup leading to a congested PNH, the ingress PFE 110A at 314 selects, according to an algorithm (e.g., hashing scheme) an adjacency ID of either the PNH or the LFA identified by the first FIB entry to be used to forward the packet. In this instance, we assume the ingress PFE 110A selected the LFA. The selected adjacency ID for the LFA is sent 316 to the egress PFE 111A, which uses the adjacency ID to determine 318 the egress port and output queue for the packet. The packet is placed in the determined output queue and eventually transmitted 320 through the port over a communications link to the third network device 104C.

Next, another packet is received from the first network device 104A by the ingress PFE 110A that matches the same first FIB entry that was matched by the first packet 322. Accordingly, a forwarding lookup 324 results in the first FIB entry being matched, which still identifies a PNH that is marked as congested. Responsive to this forwarding lookup leading to a congested PNH, the ingress PFE 110A at 326 selects, according to the algorithm an adjacency ID of either the PNH or the LFA identified by the first FIB entry to be used to forward the packet. In this instance, we assume the ingress PFE 110A selected the PNH. The selected adjacency ID for the PNH is sent 328 to the egress PFE 111A, which uses the adjacency ID to determine 318 a different egress port and output queue for this packet. The packet is placed in the determined output queue and eventually transmitted 332 through the different egress port over a different communications link to the second network device 104B.

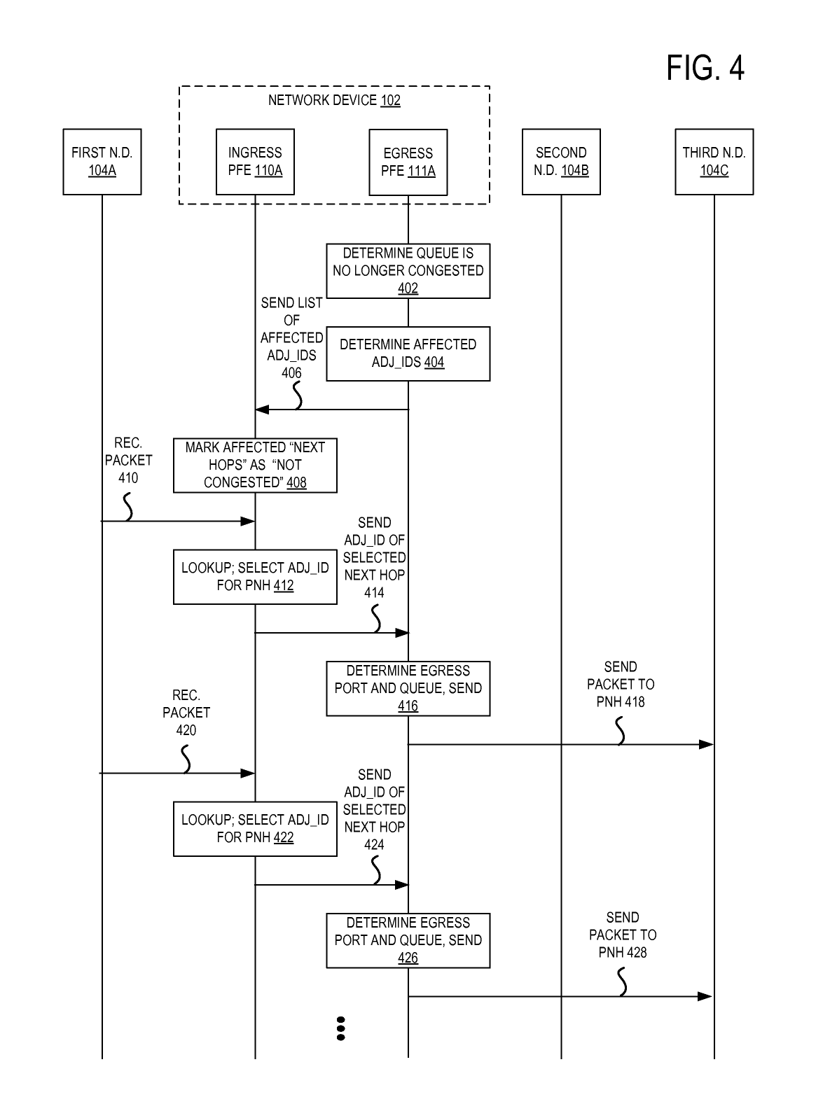

FIG. 4 illustrates a sequence diagram for ending congestion remediation LFA forwarding according to the embodiment of the invention depicted in FIG. 3. After some period of time of congestion for the output queue of the PNH (as detailed in FIG. 3), the egress PFE 111A determines that the output queue is no longer congested 402. Responsive to this determination, the egress PFE 111A determines 404 a set of affected adjacency IDs that point to the now non-congested output queue, and sends 406 a list of those adjacency IDs in the set of affected adjacency IDs to the ingress PFE 110A. The ingress PFE 110A marks 408 the PNH and LFA next hops identifying an adjacency ID in the list of adjacency IDs is being no longer congested. At this point, each received packet (410, 420) that matches a first entry in a FIB identifying a PNH that was updated to be not congested will be transmitted using the adjacency ID of the PNH. Thus, portions of those received packets are used to lookup (412, 422) the first entry in the FIB, and because the PNH is not marked as congested, that adjacency ID is selected and sent to the egress PFE 111A at 414 and 424. The egress PFE 111A will use the adjacency ID to determine (416, 426) the appropriate egress port and output queue, and will place those packets in the output queue. Then, at 418 and 428, the packets will be sent to the third network device 104C.

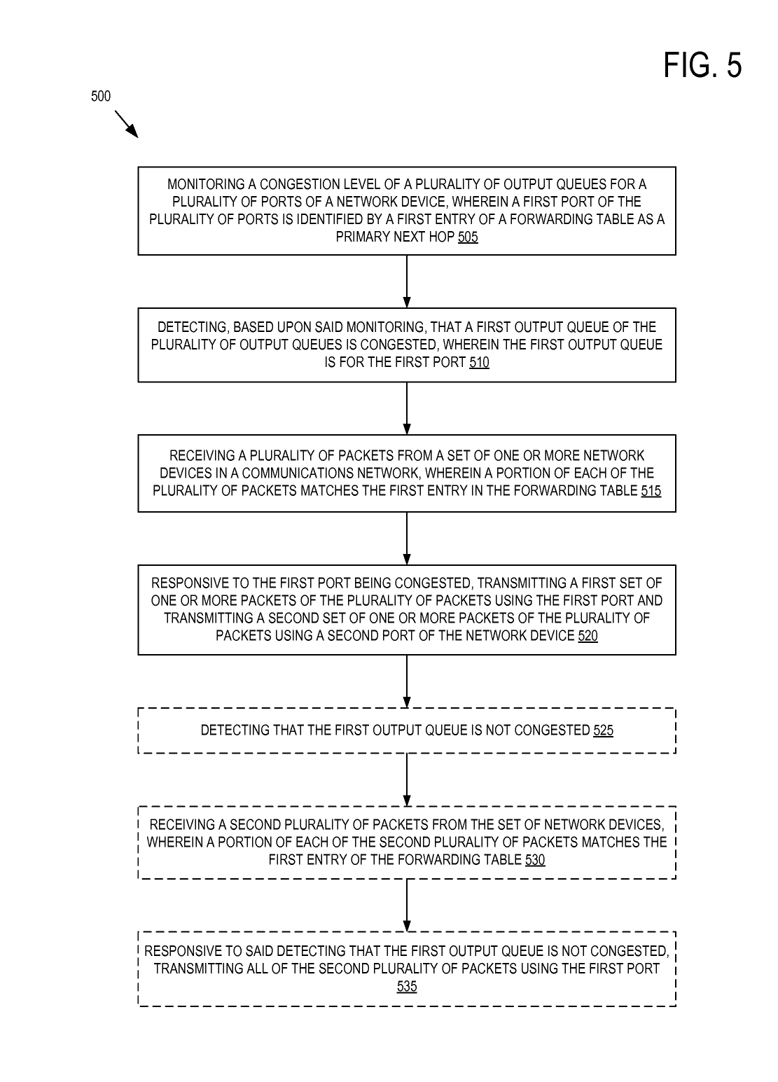

FIG. 5 illustrates a flow 500 in a network device for network congestion remediation utilizing loop free alternate load sharing according to one embodiment of the invention. The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference to these other diagrams can perform operations different than those discussed with reference to the flow diagrams.

The flow 500 begins at 505, with the network device monitoring a congestion level of a plurality of output queues for a plurality of ports of the network device. A first port of the plurality of ports is identified by a first entry of a forwarding table as a primary next hop. At 510, the network device detects, based upon said monitoring, that a first output queue of the plurality of output queues is congested. The first output queue is for the first port.

The network device receives 515 a plurality of packets from a set of one or more network devices in a communications network. A portion of each of the plurality of packets matches the first entry in the forwarding table. Responsive to the first port being congested, at 520 the network device transmits a first set of one or more packets of the plurality of packets using the first port and transmits a second set of one or more packets of the plurality of packets using a second port of the network device.

The flow 500 optionally continues to 525, where the network device detects that the first output queue is no longer congested. The network device then receives, at 530, a second plurality of packets from the set of network devices. A portion of each of the second plurality of packets matches the first entry of the forwarding table, just as a portion of each of the first plurality of packets also matched the first entry of the forwarding table. However, at 535, responsive to the detecting at 525 that the first output queue is not congested, the network device transmits all of the second plurality of packets using the first port.

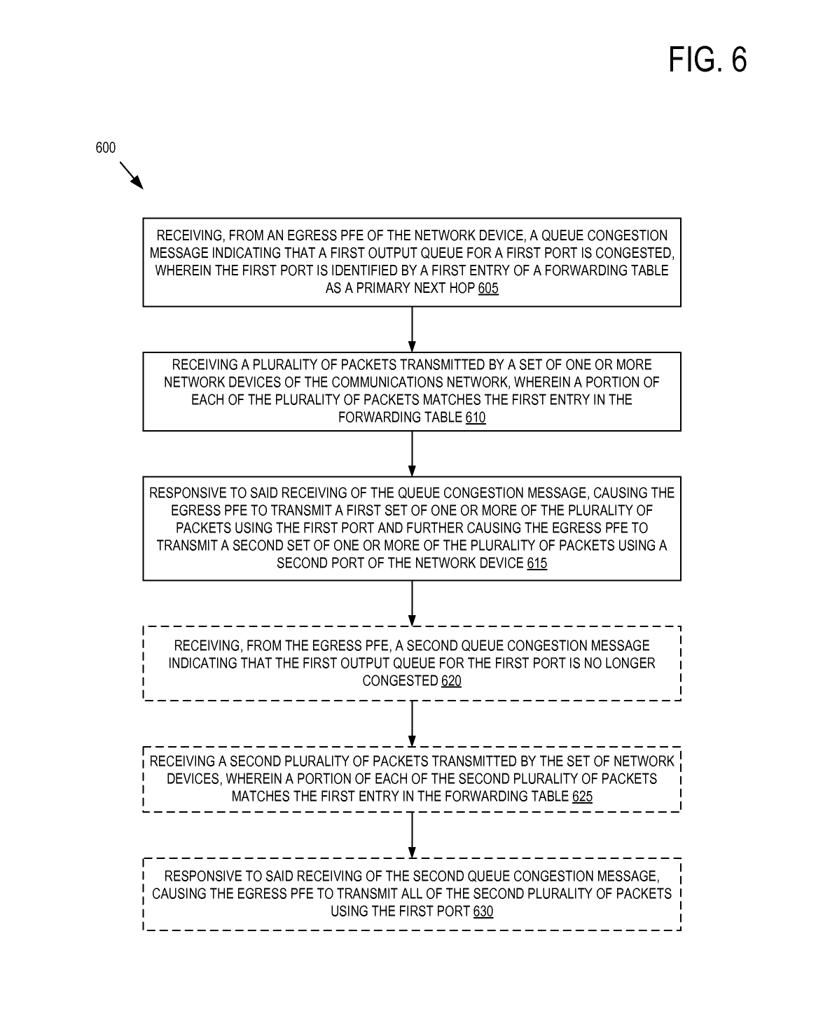

FIG. 6 illustrates a flow 600 in an ingress packet forwarding engine (PFE) for network congestion remediation utilizing loop free alternate load sharing in a network device according to one embodiment of the invention.

At 605, the ingress PFE receives, from an egress PFE of the network device, a queue congestion message. The queue congestion message indicates that a first output queue for a first port is congested. The first port is identified by a first entry of a forwarding table as a primary next hop. At 610, the ingress PFE receives a plurality of packets transmitted by a set of one or more network devices of the communications network. A portion of each of the plurality of packets matches the first entry in the forwarding table.

At 615, responsive to the ingress PFE receiving the queue congestion message, the ingress PFE causes the egress PFE to transmit a first set of one or more of the plurality of packets using the first port and further causes the egress PFE to transmit a second set of one or more of the plurality of packets using a second port of the network device.

Optionally, the flow 600 continues at 620 with the ingress PFE receiving, from the egress PFE, a second queue congestion message. The second queue congestion message indicates that the first output queue for the first port is no longer congested. At 625, the ingress PFE receives a second plurality of packets transmitted by the set of network devices. A portion of each of the second plurality of packets matches the first entry in the forwarding table.

Then, responsive to the ingress PFE receiving the second queue congestion message, the ingress PFE causes at 630 the egress PFE to transmit all of the second plurality of packets using the first port.

### Alternate Embodiments

In alternate embodiments of the invention, each entry of a FIB may point to a next hop data structure including a PNH and a plurality of LFA next hops, and upon congestion of an output queue for a port that is the PNH for a first entry of the FIB, send some packets matching the first entry using the PNH, send some packets matching the first entry using a first LFA next hop of the plurality of LFA next hops, and send some packets matching the first entry using a second LFA next hop of the plurality of next hops.

In some embodiments, if both the PNH and the LFA next hop identified by a first entry of a FIB are deemed congested, the network device will not use the LFA next hop for any traffic matching the first entry, but will instead continue to only use the PNH.

In an embodiment where the PNH and the LFA next hop identified by a first entry of a FIB are in an Equal Cost Multi-Path (ECMP) and congestion is detected on an egress output queue of the PNH, then only 50% of the traffic matching the first entry is causing the congestion of the PNH. Accordingly, in some such embodiments, the network device will utilize a hashing scheme to switch additional traffic to the LFA next hop (e.g. 30% of traffic on the PNH, 70% of traffic on the LFA next hop).

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method in a network device in a communications network for reducing congestion within the communications network, the method comprising:
monitoring a congestion level of a plurality of output queues for a plurality of ports of the network device, wherein a first port of the plurality of ports is identified by a first entry of a forwarding table as a primary next hop;
detecting, based upon said monitoring, that a first output queue of the plurality of output queues is congested, wherein the first output queue is for the first port;
receiving a plurality of packets from a set of one or more network devices in the communications network, wherein a portion of each of the plurality of packets matches the first entry in the forwarding table; and
responsive to the first port being congested, transmitting a first set of one or more packets of the plurality of packets using the first port and transmitting a second set of one or more packets of the plurality of packets using a second port of the network device.

2. The method of claim 1, further comprising:
detecting that the first output queue is not congested;
receiving a second plurality of packets from the set of network devices, wherein a portion of each of the second plurality of packets matches the first entry of the forwarding table; and
responsive to said detecting that the first output queue is not congested, transmitting all of the second plurality of packets using the first port.

3. The method of claim 2, wherein said detecting that the first output queue is not congested comprises determining that a number of queued packets of the first output queue does not meet or exceed a congestion threshold.

4. The method of claim 2, wherein:
said detecting that the first output queue is not congested comprises determining that a number of queued packets of the first output queue does not meet or exceed a low watermark congestion threshold; and
said detecting that the first output queue is congested comprises determining that the number of queued packets of the first output queue meets or exceeds a high watermark congestion threshold, wherein the high watermark congestion threshold is greater than the low watermark congestion threshold.

5. The method of claim 1, wherein said detecting that the first output queue is congested comprises determining that a number of queued packets of the first output queue meets or exceeds a congestion threshold.

6. The method of claim 1, wherein the first set of packets and the second set of packets each include substantially the same number of packets.

7. The method of claim 1, wherein the second port is identified by the first entry of the forwarding table as a loop free alternate (LFA) next hop.

8. The method of claim 1, further comprising:
for each packet of the plurality of the packets, determining whether the packet is to be included in the first set of packets or the second set of packets based upon a hashing scheme.

9. A method in an ingress packet forwarding engine (PFE) of a network device for reducing congestion within a communications network, the method comprising:
receiving, from an egress PFE of the network device, a queue congestion message indicating that a first output queue for a first port is congested, wherein the first port is identified by a first entry of a forwarding table as a primary next hop;
receiving a plurality of packets transmitted by a set of one or more network devices of the communications network, wherein a portion of each of the plurality of packets matches the first entry in the forwarding table; and
responsive to said receiving of the queue congestion message, causing the egress PFE to transmit a first set of one or more of the plurality of packets using the first port and further causing the egress PFE to transmit a second set of one or more of the plurality of packets using a second port of the network device.

10. The method of claim 9, further comprising:
receiving, from the egress PFE, a second queue congestion message indicating that the first output queue for the first port is no longer congested;
receiving a second plurality of packets transmitted by the set of network devices, wherein a portion of each of the second plurality of packets matches the first entry in the forwarding table; and
responsive to said receiving of the second queue congestion message, causing the egress PFE to transmit all of the second plurality of packets using the first port.

11. The method of claim 9, wherein the first set of packets and the second set of packets each include substantially the same number of packets.

12. The method of claim 9, wherein the second port is identified by the first entry of the forwarding table as a loop free alternate (LFA) next hop.

13. The method of claim 9, further comprising:
for each packet of the plurality of the packets, determining whether the packet is to be included in the first set of packets or the second set of packets based upon a hashing scheme.

14. The method of claim 9, wherein the queue congestion message is a Fast Failure Notification (FFN).

15. An ingress packet forwarding engine (PFE) to be utilized within a network device to reduce congestion in a communications network, the ingress PFE comprising:
an ingress forwarding module configured to,
receive, from an egress PFE of the network device, a queue congestion message indicating that a first output queue for a first port of the network device is congested, wherein the first port is identified by a first entry of a forwarding table as a primary next hop, and
receive, from a set of one or more network devices, a plurality of packets to be forwarded by the network device, wherein a portion of each packet of the plurality of packets matches the first entry of the forwarding table; and
an adjacency selection module coupled to the ingress forwarding module and configured to cause, responsive to said receipt of the queue congestion message, the egress PFE to transmit a first set of one or more of the plurality of packets using the first port and transmit a second set of one or more of the plurality of packets using a second port of the network device.

16. The ingress PFE of claim 15, wherein:
the ingress forwarding module is further configured to,
receive, from the egress PFE, a second queue congestion message indicating that the first output queue is no longer congested, and
receive a second plurality of packets transmitted by the set of network devices, wherein a portion of each of the second plurality of packets matches the first entry in the forwarding table; and
the adjacency selection module is further configured to cause, responsive to said receipt of the second queue congestion message, the egress PFE to transmit all of the second plurality of packets using the first port.

17. The ingress PFE of claim 15, wherein the first set of packets and the second set of packets each include substantially the same number of packets.

18. The ingress PFE of claim 15, wherein the second port is identified by the first entry of the forwarding table as a loop free alternate (LFA) next hop.

19. The ingress PFE of claim 15, wherein the adjacency selection module is further configured to:
for each packet of the plurality of the packets, determine whether the packet is to be included in the first set of packets or the second set of packets based upon a hashing scheme.

20. A method in a router for reducing congestion in a communications network, the method comprising:
detecting, by an egress packet forwarding engine (PFE) of the router, that an output queue for a first port of the router is congested;
sending, from the egress PFE to a set of one or more ingress PFEs of the router, a queue congestion message indicating that the output queue for the first port is congested;
receiving a plurality of packets to be forwarded, wherein a portion of each of the plurality of packets matches a first entry of a forwarding table, the first entry identifying the first port as a primary next hop and further identifying a second port of the router as a loop-free alternate (LFA) next hop;
selecting, for a first set of one or more packets of the plurality of packets, the primary next hop to be used to transmit the first set of packets;
selecting, for a second set of one or more packets of the plurality of packets, the LFA next hop to be used to transmit the second set of packets; and
transmitting the first set of packets using the first port and transmitting the second set of packets using the second port.
